(19) United States
(12) Patent Application Publication
(10) Pub. No.: US 2010/0277381 A1
(43) Pub. Date: Nov. 4, 2010

(54) Metamaterial Cloaked Antenna

(75) Inventors: Igor I. Smolyaninov, Columbia, MD (US); Nikolay K. Yushin, Herndon, VA (US); Louise C. Sengupta, Ellicott City, MD (US)

Correspondence Address: BAE SYSTEMS, PO BOX 868, NASHUA, NH, 03061-0868, US

(73) Assignee: BAE Systems Information and Electronic Systems Integration Inc., Nashua, NH (US)

(21) Appl. No.: 12/773,562

(22) Filed: May 4, 2010

Related U.S. Application Data
(60) Provisional application No. 61/175,221, filed on May 4, 2009.

(51) Int. Cl. H01Q 19/06; H01Q 1/32

(52) U.S. Cl. 343/713; 343/753

(57) ABSTRACT

In the method for operating a plurality antenna having near-field (NF) zone mounted on a vehicle, wherein the improvement comprises the step of cloaking in the near-field (NF) zone of each of said plurality of antennas.

### CROSS-REFERENCE TO RELATED APPLICATIONS

This application claims rights under 35 U.S.C. §119(e) from U.S. Application Ser. No. 61/175,221, filed. May 4, 2009, the contents of which are incorporated herein by reference.

### BACKGROUND OF THE INVENTION

1. Field of the Invention

The present invention relates to electromagnetic cloaking and more particularly to metamaterial cloaked antennas.

2. Brief Description of Prior Developments

Prior art metamaterial-based cloaking techniques are described in the following publications, the contents of which are incorporated herein by reference:

1. J. B. Pendry, D. Schurig, D. R. Smith, Science 312, 1780 (2006).

2. U. Leonhardt, Science 312, 1777 (2006).

3. D. Schurig, J. J. Mock, B. J. Justice, S. A. Cummer, J. B. Pendry, A. F. Starr, D. R. Smith, Science 314, 977 (2006).

4. W. Cai, U. K. Chettiar, A. V. Kildishev, V. M. Shalaev, Nature Photonics 1, 224 (2007).

The performance of modern and future aircraft and satellites strongly depends on various antennas. Typically, a very large number of different types of antennas are mounted on board aircraft, satellites or other vehicles in order to cover as wide a radio-frequency range and bandwidth as is possible. Because space is at a premium on board, the airborne antennas are usually located in close proximity to each other. This arrangement may cause so-called estate issues with respect to antenna installation.

A need, therefore, exists for a way of reducing the detrimental effect of co-site interference between multiple antennas densely mounted on aircraft, satellites, ships or other vehicles.

### SUMMARY OF INVENTION

According to the present invention, engineered metamaterial (MM) layers are applied to antenna surfaces to prevent the reflected/scattered radiation return on the active antenna surface. The cloaking effect is based on the ability of specially designed MM devices to prevent reflection of the electromagnetic radiation rays in such manner that the electromagnetic waves go around the object and make the object essentially “invisible”. A transformational optics approach is used for the cloaked antenna design. An important feature of method of the present invention is cloaking in the near-field (NF) zone of an antenna. The radiation field distribution in the NF region of an antenna is much more complex than in the far-field (FF) zone. Therefore, the MM structure has to be designed in a different way than has been demonstrated in early cloaks for the FF zone.

This invention also encompasses the method of improving the performance of multiple antennas mounted on board of the aircraft, satellite, ship, or any vehicle by separating the near field (NF) radiation by the metamaterial cloaks positioned between the neighbor antennas (see FIGS. 1 and 2). As a result the far field (FF) radiation patterns are significantly improved.

This invention also encompasses a cloaked antenna which directs the antenna radiation in such manner that it does not reach the neighbor objects and/or other antennas (see FIG. 2). We would like to emphasize that the metamaterial cloak developed for the purposes of this project has a different configuration than to the conventional cloaks described by the Pendry et al. and Schurig et al. references cited above.

### BRIEF DESCRIPTION OF THE DRAWINGS

The invention will be more closely understood hereinafter by reference to the drawings in which:

FIGS. 1A and 1B show drawings of an antenna cloaking by the coordinate transformation method. By selecting conformal coordinate transformation to curvilinear coordinate system schematically indicated by the black mesh, the donut-shaped region of space on the sides of the antenna is “eliminated”: from the point of view of the radiating antenna, the other antennas and/or passive sections of the aircraft located in the donut-shaped cloaked region are located at infinity. As a result, the radiation pattern of the cloaked antenna is insensitive to its ambient. The inset shows gradual change of the metamaterial parameters inside the cloak wall.

FIGS. 2A, 2B, 2C and 2D show a COMSOL simulation of the dipole near-field distribution for a single dipole (a), the dipole and metallic cylinder (b), the metallic plate positioned between the dipole and the cylinder (c), and the metamaterial flat cloak located between the dipole and the cylinder (d). In real applications the edges of the cloak will be tapered in order to reduce scattering.

FIGS. 3A and 3B show a COMSOL simulation of the NF H-field of the two dipole antennas separated by the metamaterial cloak.

FIGS. 4A, 4B, 4C, 4D and 4F show the FF radiation pattern calculated for a single patch antenna (a), the active antenna with a neighbor passive antenna at X=0.08λ (b), X=0.24λ (c), and X=0.72λ (d). The FF radiation pattern of the two antennas at X=0.08λ with the metamaterial cloak between them (e). The MM clock (with the width X and the height H) shown green is positioned between the two patch antennas shown pink (f).

FIG. 5 shows the transmission coefficient S₁₂ of the two patch antennas separated by the distance X=0.08λ (a), X=0.24λ (b), X=0.4λ (c), and X=0.72λ (d), as well as with the metamaterial cloak of the height H between the antennas at X=0.08λ and H=0.025λ (e), X=0.08λ and H=0.16λ (f).

### DETAILED DESCRIPTION OF THE PREFERRED EMBODIMENT

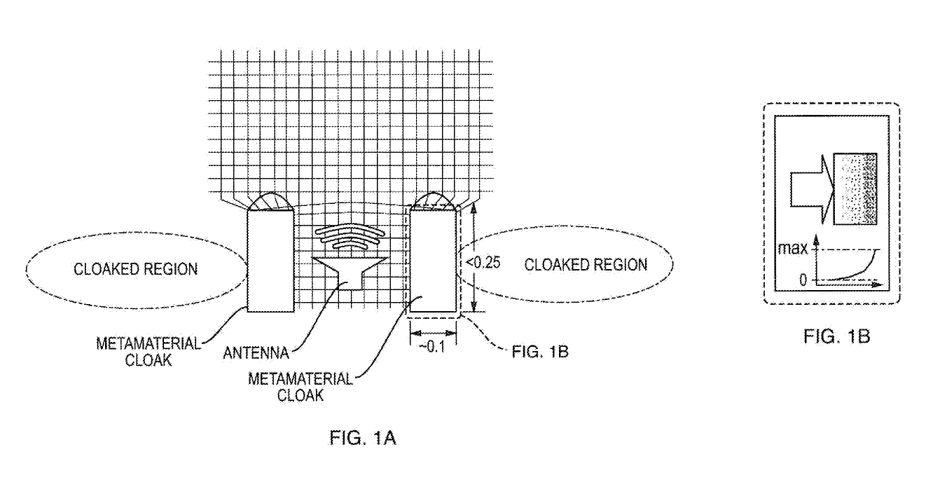

Based on the transformational optics approach we have developed a novel concept of the cloaked antenna, which is illustrated in FIG. 1. The transformational optics approach is based on the conformal coordinate transformations to a specially chosen system of curvilinear coordinates (x₁,y₁,z₁,t₁), which distort the length elements but keep the angles intact. The Maxwell equations in such a curvilinear coordinate system may be written in the usual form by introducing effective anisotropic dielectric permittivity ε(x₁,y₁,z₁) and magnetic permeability μ(x₁,y₁,z₁) tensors of free space. On the other hand, if the so obtained ε and μ distributions will be engineered artificially using specially designed metamaterial medium, electromagnetic fields in such a medium will propagate as if in normal Minkowski space described by the (x₁,y₁,z₁,t₁) coordinates. Thus, transformational optics approach to antenna cloaking is applicable to both near and far fields of a cloaked antenna.

The schematic drawing in FIG. 1 represents our conceptual approach. In real-life applications the exact configuration of the cloak needs to be tailored in order to avoid undesirable blind spots. The approximate dimensions in FIG. 1 indicate that not much of the antenna field of view will be obscured. Those skilled in the art will appreciate that if any particular application would require an omnidirectional field of view, a combination of our approach with the approach disclosed in the Pendry et al. reference (cited above) may be used, so that antenna may see behind the obscuration.

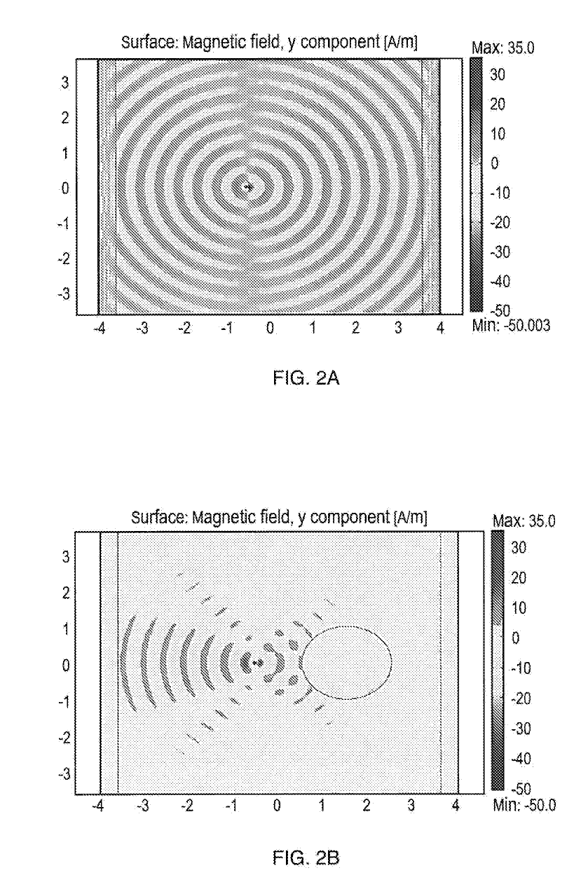

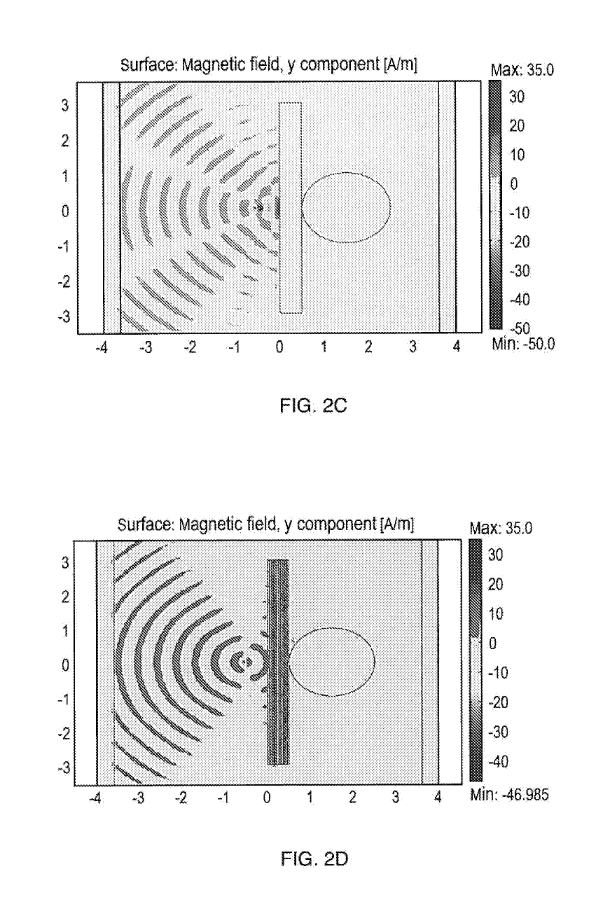

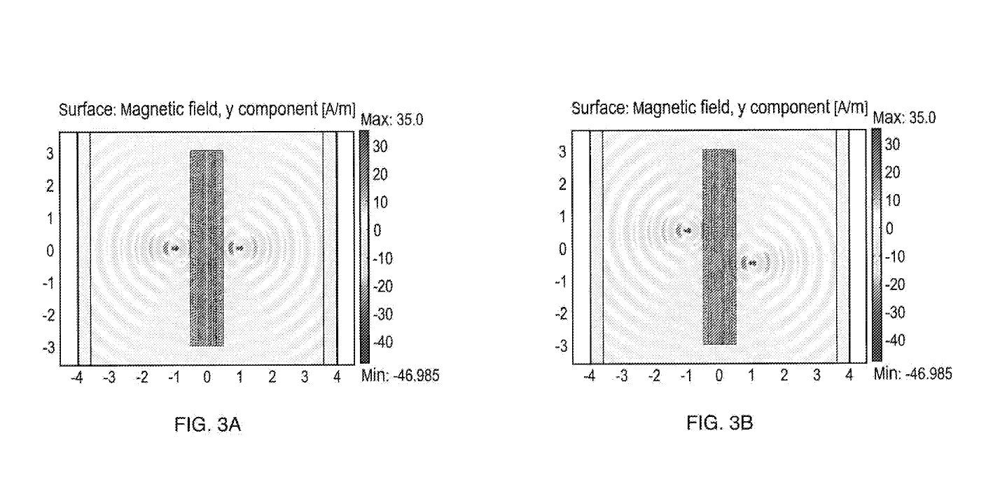

The distinctive feature of the metamaterial for cloaking applications is that its properties (dielectric permittivity c and magnetic permeability μ) are gradually changed inside the cloak, while their ratio does not. It is matched to the impedance of free space. FIG. 1 illustrates our MM cloak that is essentially multilayered dielectric structure (with some metallic particles inclusions) each layer ε (and μ) being extrapolated by the step function close to desirable ε and μ distribution. Our simulations show that significant field distortion is observed when the radiation from the dipole hits metallic objects (e.g. metal cylinder or metal plate), while in the case of the metamaterial cloak positioned between the dipole and the metal object there is no such field distortion (compare FIGS. 2b, 2c and FIG. 2d). Thus, screening the objects by metallic plate or cylinder does not prevent the radiation pattern distortion. On the other hand, two antennas may work independently without interference with each other when each antenna is cloaked, even though they are situated next to each other (FIG. 3).

The general algorithm for designing the MM cloak is the following:

Using the desired conformal coordinate transformation tensor we calculate the spatial variations of components of the permittivity ε(r) tensor and the permeability μ(r) tensor. From the so obtained ε(r) and μ(r) spatial distribution, the structure and composition of the metamaterial is determined. To simplify the cloak fabrication we will use the multilayered structure (as in the inset in FIG. 1) where the ε(r) and μ(r) function are replaced by the step-like approximation.

An underlying feature of the proposed approach is the use of the metamaterial cloaks to prevent the electromagnetic radiation from the neighbor objects (active and/or passive ones) from hitting the emitting surface of the antenna(s). This returning radiation creates the phase distortion on the surface and deteriorates the FF radiation pattern of the antenna. In the conventional approach to antenna separation one has to position the antennas in such a way that the lateral distance between them is greater than the NF zone as is described in Handbook of Antennas in Wireless Communications, Ch. 5, Antenna Parameters, Various Generic Antennas and Feed Systems, and Available Softwares, CRC, 2002, the contents of which are incorporated herein by reference, size d_{NF} (d_{NF}>>D, d_{NF}>>λ, and d_{NF}>>2D²/λ, here D is the antenna size and λ is its wavelength). Therefore, there is a room for (D+d_{NF})⁻² antennas per unit area. With the proposed metamaterial cloaks the distance d_{MM} between the antenna edges could be 0.08λ or less. Then we may put (D+d_{MM})² antennas per unit area. For d_{MM}<<D the metamaterial clock permits the position of much more antennas than a conventional spatial separation.

To evaluate significance of our approach the antenna FF radiation pattern distortion and its correction with the metamaterial cloak have been simulated by HFSS software for a set of two antennas—one is an active patch antenna and second is a passive patch antenna located on a distance X from the edge of the active antenna.

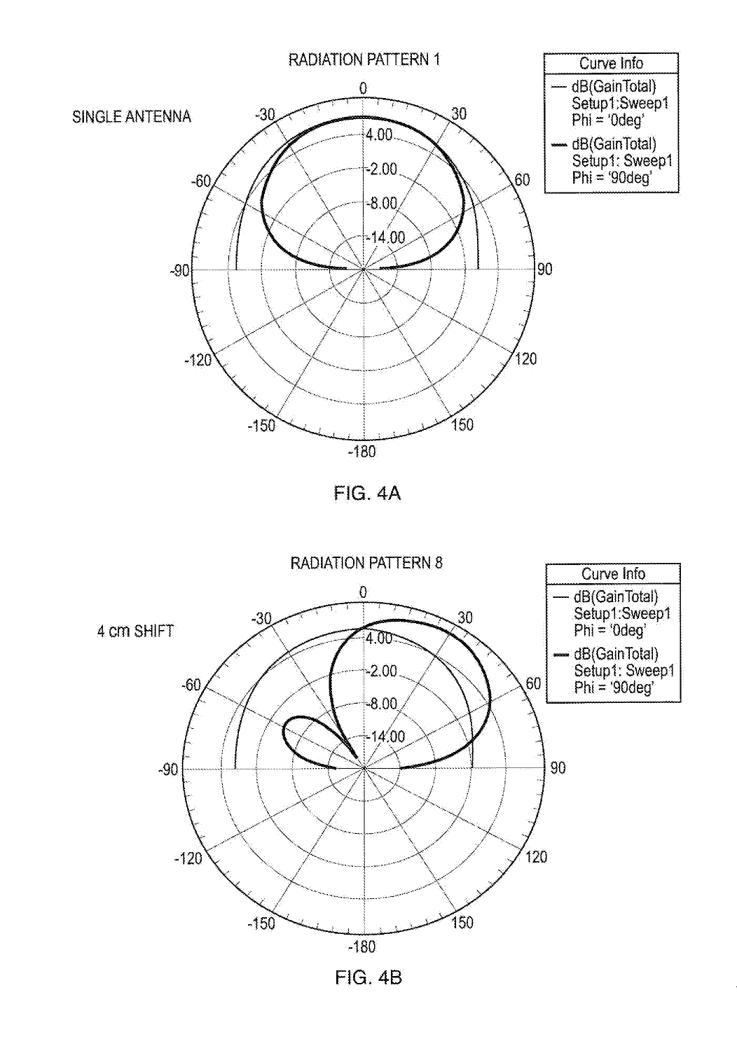

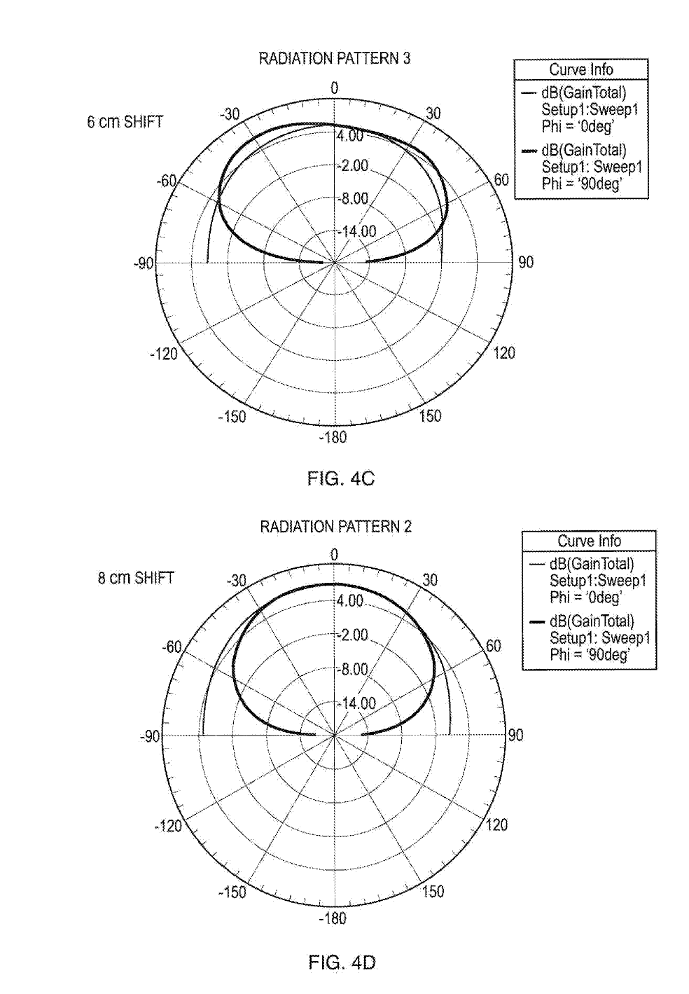

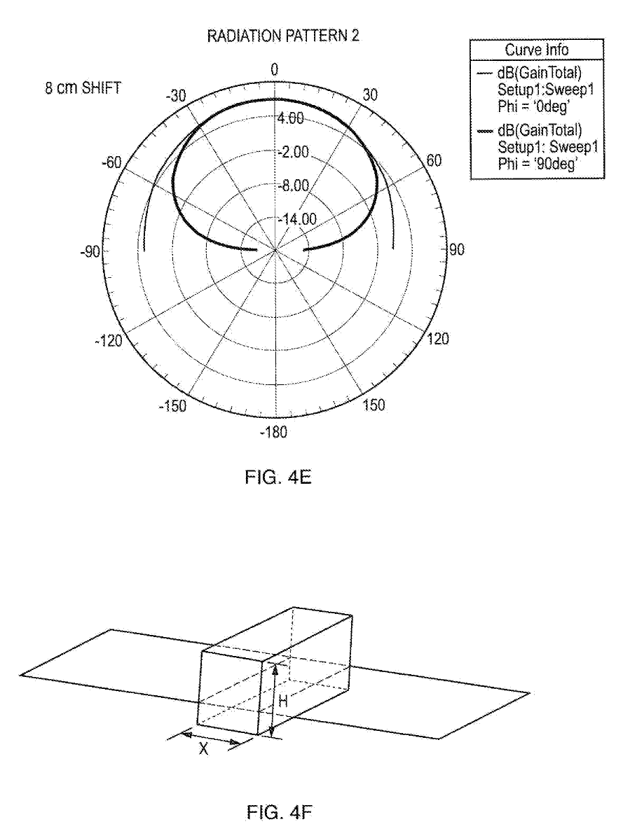

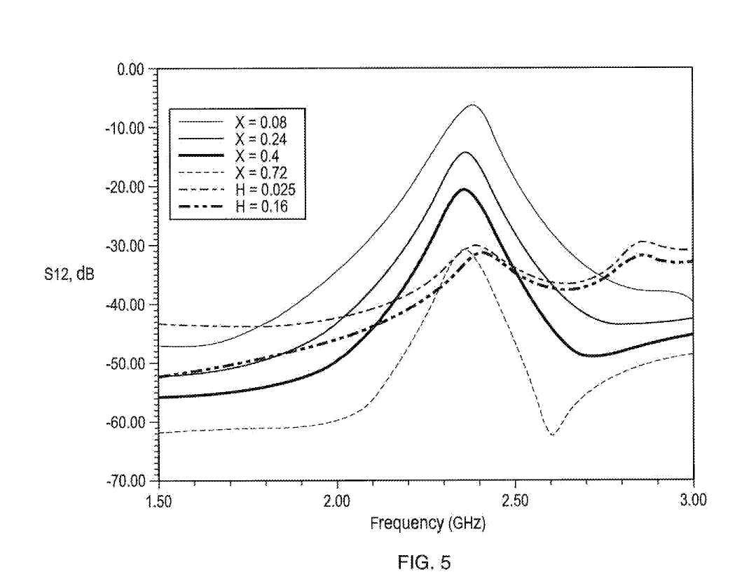

The results presented in FIG. 4 show the radiation pattern of the active antenna is drastically deteriorated at low X, but the pattern coincides with a single antenna pattern when the distance X becomes larger. Meanwhile the metamaterial clock positioned between the antennas makes the pattern looks as a single antenna one even at X=0.08λ (Compare FIGS. 4a, d, and e). Using HFSS we have also calculated the S-parameters of the set of the two identical patch antennas located at the distance X. One may see from the results presented in FIG. 5 that the closer antennas the higher the transmission S₁₂-parameter. Meanwhile the metamaterial cloak positioned between the antennas significantly decreases the S₁₂ magnitude even at the distance as small as 0.08λ with a low value of the scattering S₁₁-parameter.

Thus, our HFSS simulations demonstrate that the proposed metamaterial cloak of the thickness of only 0.08λ works as the separation of the antennas by the distance of 0.72λ.

Those skilled in the art will appreciate that any combination of metal, dielectric, ferroelectric and/or ferromagnetic materials may be used in the antenna cloak design, as long as the resulting metamaterial parameters would satisfy the desired spatial distribution of ε and μ tensors, as described in FIG. 1.

While the present invention has been described in connection with the preferred embodiments of the various figures, it is to be understood that other similar embodiments may be used or modifications or additions may be made to the described embodiment for performing the same function of the present invention without deviating therefrom. Therefore, the present invention should not be limited to any single embodiment, but rather construed in breadth and scope in accordance with the recitation of the appended claims.

What is claimed is:

1. In the method for operating a plurality antenna having near-field (NF) zone mounted on a vehicle, wherein the improvement comprises the step of cloaking in the near-field (NF) zone of each of said plurality of antennas.

2. The method of claim 1 wherein near-field (NF) radiation of neighboring radiation is separated by a plurality of metamaterial cloaks so that the far field (FF) radiator patterns are improved.

3. The method of claim 1 wherein a cloaked antenna is provided which directs radiation in such a way that said radiation is impeded from reaching neighboring antennas.

4. The method of claim 1 wherein a metamaterial cloak is used.

5. The method of claim 4 wherein using a desired conformal coordinate transformation tensor the spatial variations of components of the permittivity ε(r) tensor and the permeability μ(r) tensor is calculated.

6. The method of claim 5 wherein from ε(r) and μ(r) spatial distribution, the structure and composition of the metamaterial is determined.

7. The method of claim 6 wherein a multilayered cloak structure is used wherein ε(r) and μ(r) function are approximated by a step-like approximation.

8. The method of claim 4 wherein the metamaterial cloaks of the antennas prevent electromagnetic radiation from hitting emitting surfaces of the antenna.
